(19) United States
(12) Patent Application Publication
(10) Pub. No.: US 2009/0026765 A1
(43) Pub. Date: Jan. 29, 2009

(54) Connector Jumper

(75) Inventor: Dan Thomas Benson, Tomball, TX (US)

Correspondence Address: DUANE MORRIS LLP - Houston, 3200 SOUTHWEST FREEWAY, SUITE 3150, HOUSTON, TX, 77027, US

(73) Assignee: Oceaneering International, Inc., Houston, TX (US)

(21) Appl. No.: 12/174,133

(22) Filed: Jul. 16, 2008

Related U.S. Application Data
(60) Provisional application No. 60/951,595, filed on Jul. 24, 2007.

(51) Int. Cl. F16L 23/026

(52) U.S. Cl. 285/416

(57) ABSTRACT

A method of connecting pipe ends of two subsea pipes using a jumper includes raising two separate ends of two separate pipelines from an initial position of each of the two separate ends; creating a jumper pipe; welding a flange with a landing saddle to each pipeline end; disposing a predetermined number of cylinders at a predetermined interval offset with respect to each of the cylinders; connecting a cylinder end to a first leg of the jumper pipe; connecting a rod end to a second leg of the jumper pipe; using the cylinders to contract the jumper in a predetermined plane so that the flanges clear the pipe ends but not the flange saddles; supporting the jumper by a spreader bar; lowering the jumper over the pipeline such that the flange saddles rest on the pipeline ends; relaxing at least one of the cylinders so the jumper expands in the predetermined plane, driving the flanges onto the pipeline ends; releasing the spreader bar; and lowering the pipeline ends and jumper to a predetermined position.

### RELATION TO PRIOR APPLICATIONS

The present application claims priority in part through U.S. Provisional Application 60/951,595 filed Jul. 24, 2007.

### FIELD OF THE INVENTION

The methods described herein relate to creating and connecting jumpers to two pipeline ends. More specifically, the methods described herein relate to creating and connecting jumpers to two pipeline ends subsea.

### BACKGROUND OF THE INVENTION

Jumpers are used to connect two pipeline ends, especially subsea, whether for new construction or repair of existing installations. Most current systems and methods for connecting these two pipeline ends require four pull-in structures, two clamp connectors, two connector flanges, and a jumper.

### FIGURES

The attached figures illustrate various aspects of exemplary embodiments of the connector jumper and its method of use.

FIG. 1 is a plan view of an exemplary set of flanges, pipe ends, and jumper used with the methods described herein.

### DESCRIPTION OF EXEMPLARY EMBODIMENTS

The following describes exemplary embodiments of a method for connecting two pipeline ends such as might occur subsea. Embodiments of the connector jumper and methods described herein below require only two connector flanges plus the jumper. In this manner, the number of seals required may be reduced from two to four. The methods may further reduce installation equipment left on bottom and provide for more rapid installations of jumpers and enable more rapid installations of jumpers.

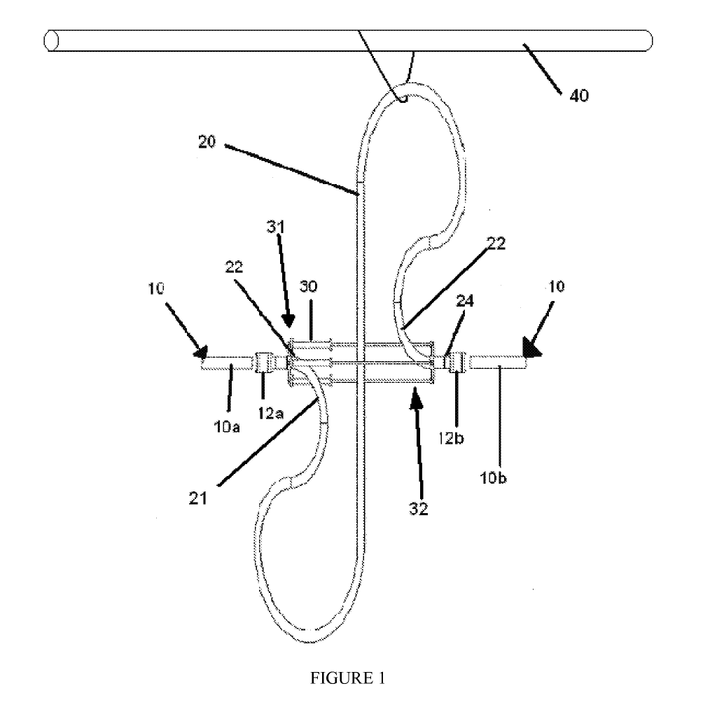

In the operation of an exemplary embodiment, referring generally to FIG. 1, pipe ends 10a, 10b of two pipes 10, e.g. subsea pipes, may be connected by raising two separate ends 10a, 10b of a pipeline 10 from an initial position of each of the two separate ends 10a, 10b. The initial locations are typically a sea floor location for one or both pipe ends 10a, 10b which may be ends of two separate pipelines 10, a set of cut ends of a single pipeline 10, a set of vertical ends of a pipeline end termination (PLET) and production tree, production, gas injection, or water injection wellhead, or the like, or a combination thereof. A lift frame may be used to raise at one or both of the two separate pipeline ends 10a,10b.

Jumper pipe 20 may be created before or after the lifting of separate ends 10a, 10b. Flanges 12a,12b are welded to a respective one of jumper ends 22,24, each flange 12a,12b comprising a landing saddle adapted to engage one of the pipelines 10. Jumper 20 is typically a suitably compliant shape such as an “S” or “M” shaped jumper and supported by spreader bar 40 which may be supported by a vessel (not shown in the figures, e.g., a heave compensated crane) or flotation. In a preferred embodiment, jumper 20 is created in part after obtaining a distance and azimuth measurement between pipeline ends 10a, 10b in a predetermined plane and using the distance and azimuth measurement to aid in creating jumper 20.

Cylinders 30 contract jumper 20 so flanges 12a,12b will clear pipe ends 10a,10b but not the flange saddles. Cylinder end 31 is connected to first leg 21 of jumper pipe 20 and connecting rod end 32 is connected to second leg 22 of jumper pipe 20.

A predetermined number of cylinders 30 are disposed at a predetermined interval offset with respect to each of the other cylinders 30. In a preferred embodiment, there are at least three cylinders 30, which may be screw jacks or the like. Cylinders 30 are typically evenly disposed at one or more predetermined interval offsets with respect to each of cylinders 30, e.g. at substantially equal predetermined interval offsets of around 120°. In a currently preferred embodiment, cylinders 30 are disposed substantially parallel to a main axis of jumper 20.

Jumper 20 is contracted in a predetermined plane using cylinders 30 so that flanges 12a,12b will clear pipe ends 10a,10b but not the flange saddles.

Jumper 20 is typically supported by spreader bar 40 and lowered over pipeline 10 such that the flange saddles rest on pipeline ends 10a,10b. In preferred embodiments, spreader bar 40 is supported by a vessel, a heave compensated crane, flotation, or the like, or a combination thereof. Spreader bar 40 may be released at any appropriate time.

Once in place, at least one of cylinders 30 is relaxed so jumper 20 “springs” back, i.e. jumper 20 expands in the predetermined plane, driving flanges 12a,12b onto pipe ends 10a,10b. Cylinders 30 may be operated substantially in tandem to contract and/or expand jumper 20. Operated in this manner, cylinders 30 contract or extend jumper 20 substantially evenly. Alternatively, cylinders 30 may be operated differentially to pitch and yaw jumper ends 22,24 of jumper 20 relative to one another.

Pipeline ends 10a,10b and jumper 20, once engaged, are then lowered to a predetermined position. Typically, once jumper 20 is installed, pipeline ends 10a,10b and jumper 20 are lowered to a mud line. Cylinders 30 may be removed after lowering pipeline ends 10a, 10b and jumper 20 to the predetermined position.

The lift frames may be recovered after jumper installation.

In a preferred embodiment, welding occurs at a surface location.

The foregoing disclosure and description of the inventions are illustrative and explanatory. Various changes in the size, shape, and materials, as well as in the details of the illustrative construction and/or a illustrative method may be made without departing from the spirit of the invention.

What is claimed is:

1. A method of connecting pipe ends of two pipes, comprising:
a. raising two separate pipeline ends from an initial position of each of the two separate ends;
b. welding a connector flange to each end of a jumper, each connector flange comprising a landing saddle adapted to engage one of the pipelines which comprises its respective pipeline end;
c. disposing a predetermined number of cylinders about each end of the jumper at a predetermined interval offset with respect to each of the cylinders;
d. connecting a cylinder end to a first leg of the jumper;
e. connecting a rod end to a second leg of the jumper;
f. using the cylinders to contract the jumper in a predetermined plane so that the flanges clear the pipe ends but not the flange saddles;
g. supporting the jumper by a spreader bar;
h. lowering the jumper over the pipeline such that the flange saddles rest on the pipeline ends;
i. expanding the jumper in the predetermined plane by relaxing at least one of the cylinders to expand the jumper, further driving the flanges onto the pipeline ends; and
j. lowering the pipeline ends and jumper to a predetermined position.

2. The method of claim 1, wherein the initial locations are at least one of a sea floor location, a set of cut ends of a single pipeline, a set of ends of two pipelines, or a set of vertical ends of a pipeline end termination and production, gas injection, or water injection wellhead.

3. The method of claim 3, further comprising:
a. activating at least one of the connector flanges; and
b. testing the activated connector flanges.

4. The method of claim 1, wherein at least one of the connector flanges is a hydraulic connector flange.

5. The method of claim 1, further comprising:
a. obtaining a distance and azimuth measurement between the pipeline ends in a predetermine plane; and
b. creating a jumper pipe using the distance and azimuth measurement.

6. The method of claim 1, wherein the jumper is at least one of a substantially “S” shaped or a substantially “M” shaped jumper.

7. The method of claim 1, further comprising preparing a jumper end prior to installing the connector flange to that jumper end.

8. The method of claim 1, further comprising removing the cylinders after lowering the pipeline ends and jumper to a predetermined position.

9. The method of claim 1, wherein the cylinders are operated substantially in tandem to contract or extend the jumper.

10. The method of claim 1, wherein the cylinders are operated differentially to pitch and yaw the ends of the jumper relative to one another.

11. The method of claim 1, wherein the cylinders comprise screw jacks.

12. The method of claim 1, further comprising using a lift frame to raise at least one of the two separate pipeline ends.

13. The method of claim 1, wherein the predetermined number of cylinders is at least 3.

14. The method of claim 1, wherein the predetermined number of cylinders are substantially evenly disposed at the predetermined interval offset with respect to each of the cylinders.

15. The method of claim 14, wherein the predetermined interval offset is around 120°.

16. The method of claim 1, wherein the predetermined number of cylinders are disposed parallel to a main axis of the jumper.

17. The method of claim 1, wherein the spreader bar is supported by at least one of a vessel, a heave compensated crane, or flotation.

18. The method of claim 1, wherein the spreader bar is released at a predetermined time.

19. The method of claim 1, further comprising recovering the lift frames after jumper installation.

20. The method of claim 1, wherein the pipeline ends and jumper, after being joined, are lowered to a mud line.
